(19) United States
(12) Patent Application Publication
(10) Pub. No.: US 2007/0213951 A1
(43) Pub. Date: Sep. 13, 2007

(54) METHOD AND SYSTEM FOR AUTOMATICALLY MONITORING THE READ QUALITY OF AN RFID SYSTEM

(75) Inventor: Hendrick L. Van Eeden, Gauteng (ZA)

Correspondence Address: WELSH & KATZ, LTD, 120 S RIVERSIDE PLAZA, 22ND FLOOR, CHICAGO, IL, 60606, US

(73) Assignee: IPICO INNOVATION INC., Aurora (CA)

(21) Appl. No.: 11/684,445

(22) Filed: Mar. 9, 2007

(30) Foreign Application Priority Data
Mar. 13, 2006 (ZA) 2006/02095

(51) Int. Cl. G01C 25/00; H04Q 5/22; G01N 37/00; G08B 13/14

(52) U.S. Cl. 702/116; 340/572.1; 340/10.1; 702/81

(57) ABSTRACT

A radio frequency identification system comprises a reader associated, in use, with a transmitted beam of radio frequency energy and a plurality of transponders to be energized by the energy and each of which intermittently retransmits a response signal to be read by the reader. A method of monitoring the read quality of the reader comprises the steps of causing the transponders and beam to move relative to one another and defining a sequence of groups of transponders in the beam. For each transponder in a group, receiving the response signals transmitted and recording (68) a read count which is equal to the number of times the response signals was received and read by the reader while the transponder is in the beam. Thereafter computing (70) a statistical distribution of number of transponders against read count in the group. Data associated with the distribution is processed and compared (72) to stored historical data relating to a previously computed distribution for a previous group in the sequence. If in the comparison a predetermined deviation is established, a first indication is provided (74).

### INTRODUCTION AND BACKGROUND

This invention relates to radio frequency identification (RFID) systems and more particularly to a system and method of automatically monitoring the read quality of the system.

RFID systems wherein passive transponders are continuously moved through an energizing signal beam of a reader, are well known. For example, the transponders may be attached to host articles and the articles may be moved through the beam on a conveyor belt. The reader is configured to read the transponders in known manner. The read quality of a system of this kind may be influenced negatively by factors such as changes in the beam pattern or profile, transponders that are suspect or faulty and system configuration changes as a result of which the transponders are not or no longer in suitable positions relative to the beam. In time critical systems, it is desirous to detect the aforementioned problems as soon as possible, and to take timeous remedial action, for example to call out technical staff to attend to the problem.

In some applications, an unknown number of transponders may be clumped or clustered together and subjected to a reader to be read. In such applications it is difficult to determine for how long the clump must be subjected to the beam until all or a satisfactory number of transponders are read.

### OBJECT OF THE INVENTION

Accordingly, it is an object of the present invention to provide a method and system with which the applicant believes the aforementioned problems may at least be alleviated.

### SUMMARY OF THE INVENTION

According to the invention there is provided a method of monitoring the reading quality of a radio frequency identification system comprising a reader associated, in use, with a transmitted beam of radio frequency energy and a plurality of transponders to be energized by the energy and each of which intermittently retransmits a response signal to be read by the reader, the method comprising the steps of:
causing the transponders and beam to move relative to one another;
defining a sequence of groups of transponders in the beam;
for each transponder in a group, receiving the response signals transmitted and recording a read count which is equal to the number of times the response signals was received and read by the reader while the transponder is in the beam;
computing a statistical distribution of number of transponders against read count for the group of transponders;
processing data associated with the distribution and comparing the data to stored historical data relating to a previously computed distribution for a previous group in the sequence; and
if in the comparison, a predetermined deviation is established, causing a first indication to be provided.

The distribution may be computed intermittently, typically periodically, in respect of a changing transponder population defined by a sliding window based on time, alternatively total number of transponders.

The data associated with the distribution may be data relating to key values of the distribution, such as average value, standard deviation etc.

The method may also include the step of, for each transponder in the group, comparing the read count to a first threshold value and if the read count is less than the threshold limit value, to cause a second indication to be provided. The first threshold value preferably is a user selectable value and may represent a lower acceptable limit value for the read count of any transponder.

According to another aspect of the invention these is provided a system for monitoring the read quality of a radio frequency identification system comprising a reader associated in use with a transmitted beam of radio frequency energy and a plurality of transponders to be energized by the energy and each of which transponders intermittently retransmits a response signal to be read by the reader, the system comprising:
a controller connected to the reader and for receiving from the reader, read data relating to each transponder in the beam;
a computing device connected to the controller for determining and recording from the read data and for each transponder, a read count which is equal to the number of times that a response signal from the transponder was received and read by the reader while the transponder is in the beam;
the computing device being configured to compute a statistical distribution of number of transponders against read count;
the computing device further being configured to process data associated with the distribution;
a comparator for comparing the data associated with the distribution to historical data stored in a memory arrangement and associated with a previously computed distribution; and
an indicator operable by the controller to provide a first indication if in the comparison, a predetermined deviation is established.

Further included within the scope of the invention is a method of reading a predetermined proportion of a clump of an unknown number of transponders of a radio frequency identification system, the method comprising the steps of:
maintaining the clump and an energizing signal beam of a reader of the system substantially stationary relative to one another;
during each of a plurality of time periods, taking sample data relating to a total number of transponders in the clump read for a first time;
utilizing the sample data to compute an expected total time to read the predetermined proportion; and
causing the reader to read for the expected total time.

Also included within the scope of the present invention is a reading system for automatically reading a predetermined proportion of a clump of an unknown number of transponders of a radio frequency identification system, the reading system comprising:
a reader which in use is held stationary relative to the clump;
a controller connected to the reader and configured to determine during a plurality of time periods, respective sample data relating to a total number of transponders in the clump read for a first time;
a computing device for computing from the sample data a total time period to read the predetermined proportion of the transponders; and
the controller being configured to cause the reader to read transponders for the total time period.

### BRIEF DESCRIPTION OF THE ACCOMPANYING DIAGRAMS

The invention will now further be described, by way of example only, with reference to the accompanying diagrams wherein

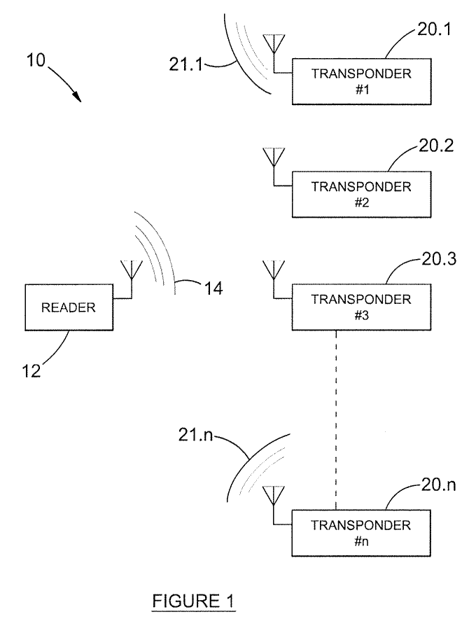

FIG. 1 is a basic block diagram of a known radio frequency identification (RFID) system;

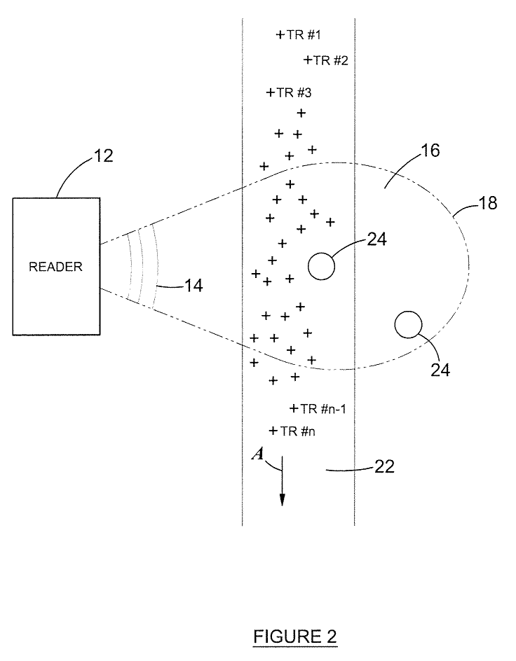

FIG. 2 is a diagram illustrating a plurality of transponders of the system being transported through a beam of a reader of the system on a conveyor belt;

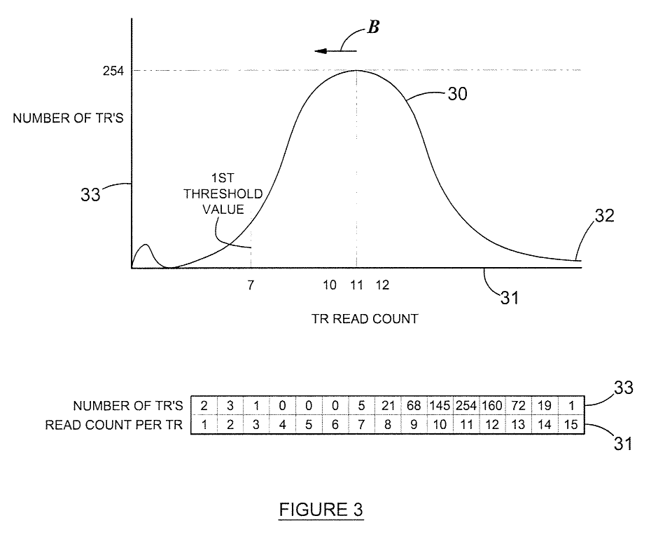

FIG. 3 is a table of “read count” against “number of transponders with that read count” while in the beam, and a graphical representation of number of transponders against read count;

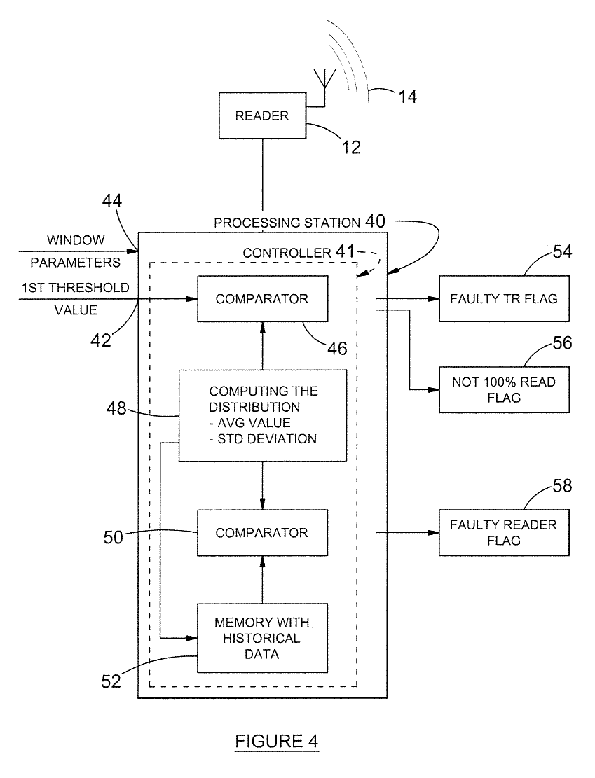

FIG. 4 is a basic block diagram of part of the system according to the invention for monitoring the read quality of the RFID system;

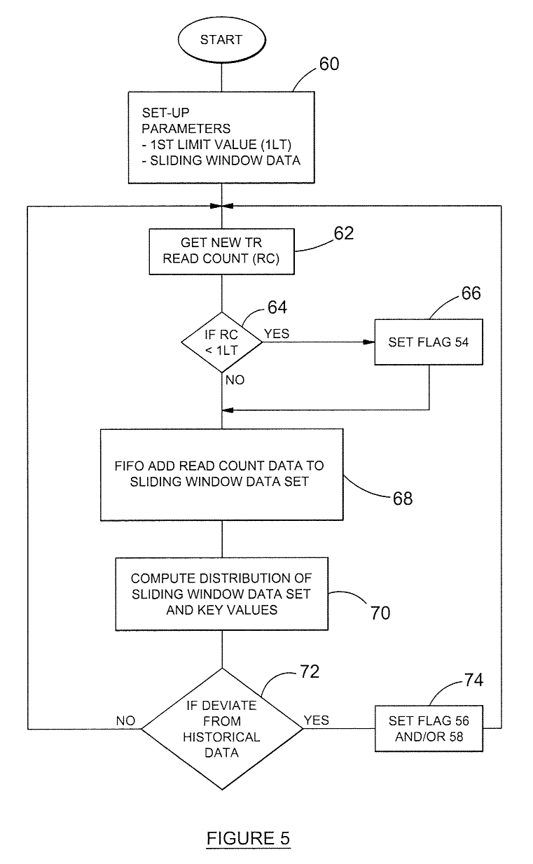

FIG. 5 is a flow diagram of the method according to the invention of monitoring the read quality of the RFID system;

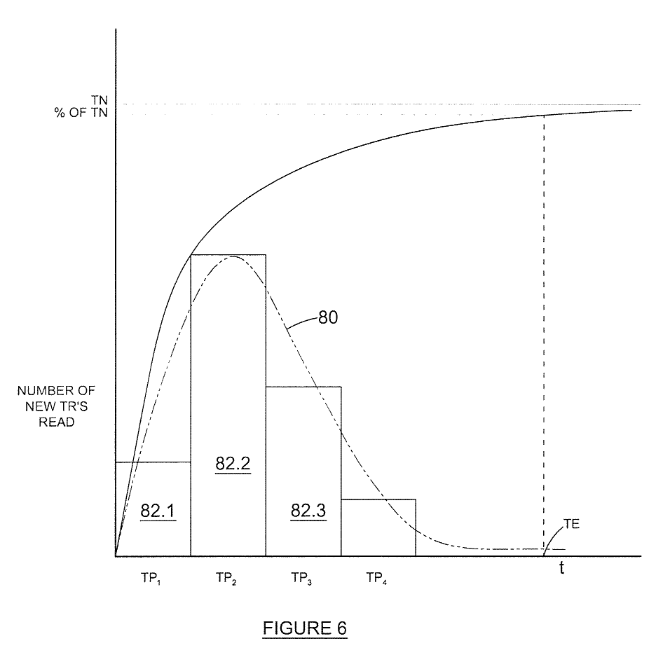

FIG. 6 a graphic representation of samples of new transponders in a clump of transponders read per time period in an application wherein a beam and the clump in the beam are stationary relative to one another; and

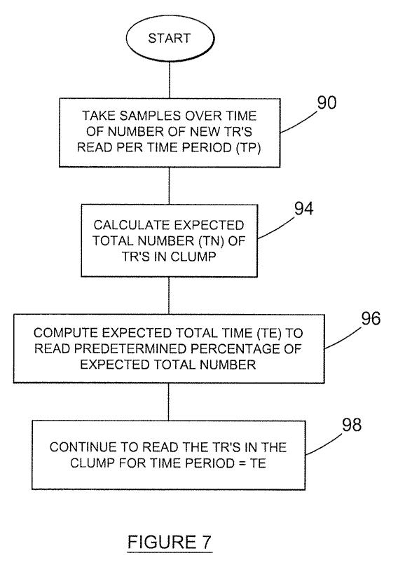

FIG. 7 is a flow diagram of a method of determining when an acceptable number of the transponders in the clump have been read.

### DESCRIPTION OF A PREFERRED EMBODIMENT OF THE INVENTION

A known radio frequency identification system is generally designated by the reference numeral 10 in FIG. 1.

The system 10 comprises a reader 12, which, in use, broadcasts an energizing signal 14 in a beam 16 (shown in FIG. 2) having a pattern and/or profile 18. Transponders 20.1 to 20.n of the system derive energy from the signal and automatically respond according to a suitable collision avoidance protocol with respective response signals 21.1 to 21.n comprising response data, which is typically back-scatter modulated on the energizing signal. The reader 12 receives the response signal, reads the data and then counts or identifies the transponders 20.1 to 20.n by the response data. One suitable protocol is a tag-talk-only (TTO) protocol wherein the reader 12 does not modulate the energizing signal. Such a protocol is described in more detail in U.S. Pat. No. 6,154,136 to Van Eeden entitled “Free running RF identification system with increasing average inter transmission intervals”. In this protocol, each transponder automatically and intermittently retransmits the response signal with the response data with increasing average inter-transmission intervals.

As is well known in the art, the transponders may be attached or adhered in the form of tags to host articles (not shown) and the system hence facilitates automatic electronic counting an/or identification of the host articles.

Referring to FIG. 2, in some practical applications of RFID systems, for example in manufacturing plants for the host articles, the host articles with respective transponders TR#1 to TR#n attached thereto as aforesaid, are caused to move relative to the beam 16, to enable the reader 12 to read the transponders. The articles may be moved as aforesaid on a conveyor 22 in direction A. The read quality of the system may be influenced negatively by factors such as changes in the beam pattern (which is determined by features such as nulls 24 in the beam due to multi-pathing, etc) or beam profile 18, transponders that are suspect or faulty and conveyor system configuration changes, as a result of which the transponders are not or no longer in suitable positions relative to the beam. In time critical systems, it is desirous to detect the aforementioned problems as soon as possible, and to take timeous remedial action, for example to call out technical staff to attend to the problem.

Referring to FIG. 3, it has been found that in a properly working system 10 wherein there is relative movement between the beam 16 and the transponders TR#1 to TR#n, either as aforesaid or in that the beam is scanned or swept over a plurality of transponders, and for a group of the transponders defined by a sliding window on a FIFO basis, either based on time or total number of transponders read, the statistical distribution of “number of transponders” 33 against “read count” 31 for those transponders is typically a normal distribution. A table with exemplary data 31 and 33 is also shown in FIG. 3. By way of example, according to the representation and data in FIG. 3, 254 transponders were read 11 times each while in the beam; 145 transponders were read 10 times each while in the beam; and 160 transponders were read 12 times each while in the beam. These figures are purely illustrative, since every set-up will look different.

With the distribution shown in FIG. 3, it is likely that all transponders passing through the beam 16 would be read more than once. However, it has been found that as the read environment is changing over time, the bell shape 30 of the distribution moves. A deteriorating reader 12 will result in a slow movement in direction B, whilst changes in the beam profile 18 and/or pattern 20 may result in more abrupt movement. Movement of any part of the bell shape beyond a threshold value should hence result in an indication being provided, for example by triggering or setting a flag.

Movement or changes in the bell shape 30 may be determined in well-known manner by computing key values of the distribution such as average value, standard deviation etc and comparing data relating to these values with stored historical data relating to corresponding values associated with a previously computed distribution derived from the sliding window. More particularly, by defining a sequence of successive groups of transponders in the beam utilizing the sliding window, the statistical distribution as aforesaid and key values for each group of transponders are computed and compared with that of a preceding group in the sequence of groups.

In a practical application of the system and method according to the invention, a user may select a minimum number or first threshold value of read counts that are required to provide a large enough safety margin to ensure that all transponders passing through the beam are in fact read. If the bell shape distribution derived by the method and system according to the invention in practice includes this first threshold value, there is a likelihood that with deterioration of the system, some transponders may in use not be read. In FIG. 3, a first threshold value of 7 is selected as an example. It is clear from the figure that at least some transponders will be read less than seven times and, in some applications, this may result in unacceptable reading results if the reader environment deteriorates. If the bell shape 30 remains in the original position, the fact that some transponders are read less than the first threshold value, is indicative of faulty or suspect transponders in the system 10. Similarly, transponders that are read more times than represented by an upper edge 32 of the bell shape, indicate that some transponders probably spent too much time in the beam 16, which may be indicative of another problem that requires remedial action.

Referring to FIG. 4, the system according to the invention comprises a processing station 40 comprising a controller 41 connected to an output of the reader 12. The processing station is configured to receive from a user at least two set-up parameters namely the aforementioned first threshold value 42 and data 44 relating to the sliding window. The processing station further comprises a first comparator 46, computing means 48 for intermittently, preferably periodically, computing the statistical distribution of transponders in a group of a sequence of groups as aforesaid and key values associated with the distribution, a second comparator 50 and a memory arrangement 52 for storing data, including historical data relating to said key values of previously computed distributions. As will hereinafter be described, the controller is configured to generate a “faulty or suspect transponder” flag 54, “not 100% read” flag 56 and a “faulty reader” flag 58.

Referring now to FIG. 5, the processing station 40 is provided at 60 with set-up data comprising at least the first threshold value and data relating to a suitable sliding window. The station then determines at 62 for each transponder in a group, transponder read count (RC) data, that is data relating to the number of times the reader 12 has read the transponder while in the beam 16. At 64, the comparator 46 compares the RC data to the first threshold value data. If the RC data is less than the first threshold value data, the controller causes at 66 the “faulty or suspect transponder” flag 54 to be set. The aforementioned RC data is then added at 68 on a first-in-first-out (FIFO) basis to a sliding window data set. Utilizing the current sliding window data set and at 70, the station computes the statistical distribution of the sliding window data set as well as data relating to the aforementioned key values associated with the distribution. The computed data is compared at 72 by comparator 50 and if a predetermined deviation from the corresponding historical data stored in memory arrangement 52 is detected, the station causes “faulty reader” flag 58 and/or “not 100% count” flag 56 to be set at 74. The aforementioned computed data is stored in memory arrangement 52 for future similar comparisons.

The invention also extends to a method and system for automatically determining an expected total read time (TE) to read a predetermined proportion or percentage of a clump of transponders comprising an unknown total number of transponders and which clump is stationary relative to a beam 16 of a reader 12. It has been found that the rate at which new transponders are read, or, in other words, the rate at which transponders are read for the first time, exhibit the characteristic shown at 80 in FIG. 6.

The method of automatically determining the expected total read time is illustrated in FIGS. 6 and 7. In a first step at 90, samples 82.1 to 82.3 of number of new transponders read per time period (TP1 to TP3) are taken by a controller connected to the reader. At 94, the sample data is used by a computing device to compute with the aid of the characteristic or model of the characteristic an expected total number (TN) of transponders in the clump. At 96 and utilizing the sample data, read rate data and the expected total number of transponder data, an expected total time period of length TE to read a predetermined percentage of the expected total number of transponders (% of TN) is computed. The reader 12 of the system 10 is then caused by the controller at 98 to continue reading transponders for a time period=TE, thereby to read the predetermined proportion.

A typical application of this method may be in a reading portal (not shown) where a plurality of readers 12 may be housed. The host articles with transponders TR#1 to TR#n to be read may be located on a fork-lift, for example. If the transponders are exposed for TE to the reader, the predetermined percentage of an unknown number of transponders is expected to be read successfully.

1. A method of monitoring the reading quality of a radio frequency identification system comprising a reader associated, in use, with a transmitted beam of radio frequency energy and a plurality of transponders to be energized by the energy and each of which intermittently retransmits a response signal to be read by the reader, the method comprising the steps of:
causing the transponders and beam to move relative to one another;
defining a sequence of groups of transponders in the beam;
for each transponder in a group, receiving the response signals transmitted and recording a read count which is equal to the number of times the response signals was received and read by the reader while the transponder is in the beam;
computing a statistical distribution of number of transponders against read count for the group of transponders;
processing data associated with the distribution and comparing the data to stored historical data relating to a previously computed distribution for a previous group in the sequence; and
if in the comparison, a predetermined deviation is established, causing a first indication to be provided.

2. A method as claimed in claim 1 wherein the groups are defined by a sliding window based on time, alternatively total number of transponders in the group.

3. A method as claimed in claim 1 wherein the data associated with the distribution comprises data relating to at least one key value of the distribution selected from the group comprising average value and standard deviation.

4. A method as claimed in claim 1 comprising the step of, for each transponder in the group, comparing the read count to a first threshold value and if the read count is less than the first threshold value, to cause a second indication to be provided.

5. A method as claimed in claim 4 wherein the first threshold value is a user selectable value and represents a lower acceptable limit value for the read count of any transponder.

6. A system for monitoring the read quality of a radio frequency identification system comprising a reader associated in use with a transmitted beam of radio frequency energy and a plurality of transponders to be energized by the energy and each of which transponders intermittently retransmits a response signal to be read by the reader, the system comprising:
a controller connected to the reader and for receiving from the reader, read data relating to each transponder in the beam;
a computing device connected to the controller for determining and recording from the read data and for each transponder, a read count which is equal to the number of times that a response signal from the transponder was received and read by the reader while the transponder is in the beam;
the computing device being configured to compute a statistical distribution of number of transponders against read count;
the computing device further being configured to process data associated with the distribution;
a comparator for comparing the data associated with the distribution to historical data stored in a memory arrangement and associated with a previously computed distribution; and
an indicator operable by the controller to provide a first indication if in the comparison, a predetermined deviation is established.

7. A method of reading a predetermined proportion of a clump of an unknown number of transponders of a radio frequency identification system, the method comprising the steps of:
maintaining the clump and an energizing signal beam of a reader of the system substantially stationary relative to one another;
during each of a plurality of time periods, taking sample data relating to a total number of transponders in the clump read for a first time;
utilizing the sample data to compute an expected total time to read the predetermined proportion; and
causing the reader to read for the expected total time.

8. A reading system for automatically reading a predetermined proportion of a clump of an unknown number of transponders of a radio frequency identification system, the reading system comprising:
a reader which in use is held stationary relative to the clump;
a controller connected to the reader and configured to determine during a plurality of time periods, respective sample data relating to a total number of transponders in the clump read for a first time;
a computing device for computing from the sample data a total time period to read the predetermined proportion of the transponders; and
the controller being configured to cause the reader to read transponders for the total time period.
